(19) United States
(12) Patent Application Publication
(10) Pub. No.: US 2025/0323951 A1
(43) Pub. Date: Oct. 16, 2025

(54) COMPLIANCE-BASED MULTI-FACTOR AUTHORIZATION

(71) Applicant: Cisco Technology, Inc., San Jose, CA (US)

(72) Inventors: Marcelo Yannuzzi, Nuvilly (CH); Arash Salarian, Chardonne (CH); Jean Andrei Diaconu, Gaillard (FR); Hervé Muyal, Gland (CH)

(73) Assignee: Cisco Technology, Inc., San Jose, CA (US)

(21) Appl. No.: 18/931,598

(22) Filed: Oct. 30, 2024

Related U.S. Application Data
(60) Provisional application No. 63/633,444, filed on Apr. 12, 2024.

(51) Int. Cl. H04L 9/40; H04L 41/16

(52) U.S. Cl. CPC H04L 63/20; H04L 41/16; H04L 63/107

(57) ABSTRACT

In one implementation, a device identifies an intended action that a user wishes to perform with respect to a service. The device makes a first determination as to whether the user is authorized to access the service. The device causes a chat session with the user to obtain information indicative of a data set, an intended use of the data set, and a data processor to perform the intended action. The device makes, based on the information from the chat session, a second determination as to whether the intended action would violate an access control policy. The device prevents performance of the intended action based on the first determination and on the second determination.

### RELATED APPLICATION

This application claims priority to U.S. Prov. Appl. Ser. No. 63/633,444, filed Apr. 12, 2024, for COMPLIANCE-BASED MULTI-FACTOR AUTHORIZATION, by Yannuzzi, et al., the contents of which are incorporated herein by reference.

### TECHNICAL FIELD

The present disclosure relates generally to compliance-based multi-factor authorization.

### BACKGROUND

The use of generative artificial intelligence (AI) is helping to augment the productivity across enterprises. For example, sales, marketing, customer support, data analytics, engineering, or product management departments all increasingly utilize generative AI. Indeed, several enterprises are utilizing pre-trained large language models (LLMs) and/or fine-tuned models and agents offered or hosted by third-party providers. These models are typically served as part of larger systems that may also include pre-integrated application programming interfaces (APIs) and/or tools to orchestrate, execute, and chain various tasks before responding to a query carried in a prompt.

With the proliferation of generative AI, though, comes increasing challenges with respect to enforcing data governance policies. For instance, given a particular data set, is the enterprise even authorized to use that data set for model training? Indeed, various legal, regulatory, and internal policies may place strict controls over the storage, access, and use of that data (e.g., data minimization rules under GDPR, the upcoming EU AI Act, etc.).

To complicate things further, different geographic locations have different requirements. This may raise additional questions such as: a.) “What are the differences between geographical jurisdictions under which the original data sets were hosted and the platform and/or the instances in which the data was used/processed for model training purposes?”, b.) “Are those locations and the data transfer compliant with corporate policy and/or legal obligations?”, c.) “In fact, are the chosen pre-trained models lawful processors?”, etc.

Existing identity and access management (IAM) and/or single sign on (SSO) services are not equipped to address and/or ensure answers to these types of data compliance related questions.

### BRIEF DESCRIPTION OF THE DRAWINGS

The implementations herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIG. 3 illustrates and example of an environment for ML/GenAI platform training;

FIG. 4 illustrates an example of an architecture for compliance-based multi-factor authorization;

FIG. 5 illustrates an example of operations of a compliance agent within the architecture of FIG. 4; and

FIG. 6 illustrates an example of a simplified procedure for compliance-based multi-factor authorization, in accordance with one or more implementations described herein.

### DESCRIPTION OF EXAMPLE IMPLEMENTATIONS

### Overview

According to one or more implementations of the disclosure, a device identifies an intended action that a user wishes to perform with respect to a service. The device makes a first determination as to whether the user is authorized to access the service. The device causes a chat session with the user to obtain information indicative of a data set, an intended use of the data set, and a data processor to perform the intended action. The device makes, based on the information from the chat session, a second determination as to whether the intended action would violate an access control policy. The device prevents performance of the intended action based on the first determination and on the second determination.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

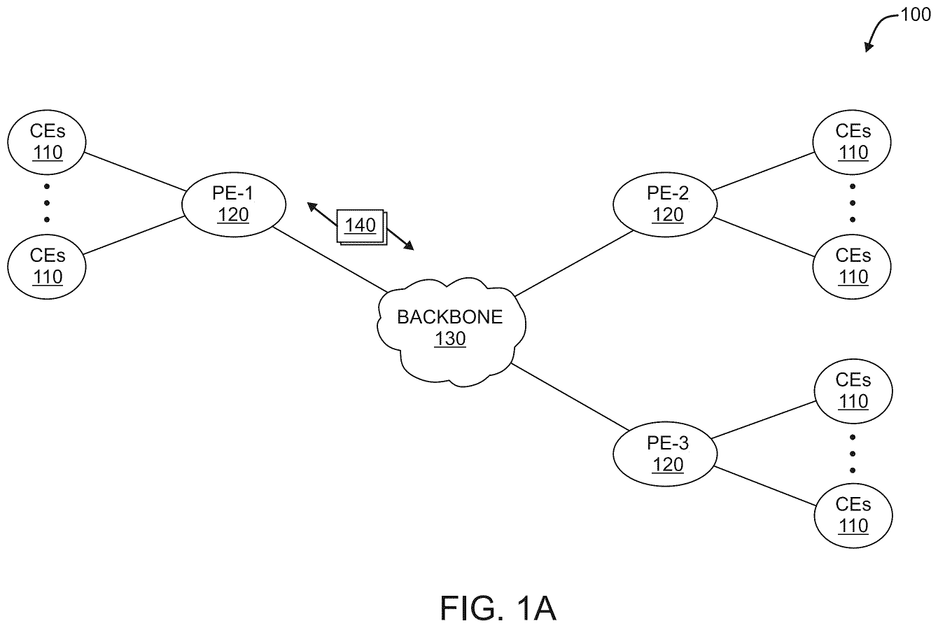

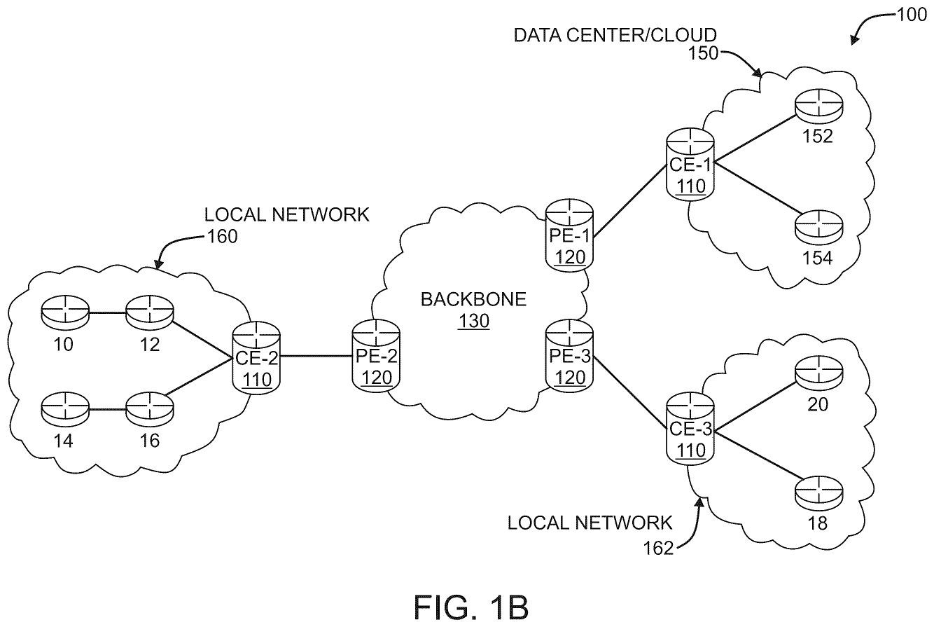

FIG. 1A is a schematic block diagram of an example computer network 100 illustratively comprising nodes/devices, such as a plurality of routers/devices interconnected by links or networks, as shown. For example, customer edge (CE) routers (e.g., CE router(s) 110) may be interconnected with provider edge (PE) routers (e.g., PE router(s) 120) (e.g., PE-1, PE-2, and PE-3) in order to communicate across a core network, such as an illustrative network backbone (e.g., network backbone 130). For example, CE router(s) 110, PE router(s) 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1.) Site Type A: a site connected to the network (e.g., via a private or VPN link) using a single CE router and a single link, with potentially a backup link (e.g., a 3G/4G/5G/LTE backup connection). For example, a particular CE router(s) 110 shown in computer network 100 may support a given customer site, potentially also with a backup link, such as a wireless connection.
2.) Site Type B: a site connected to the network by the CE router via two primary links (e.g., from different Service Providers), with potentially a backup link (e.g., a 3G/4G/5G/LTE connection). A site of type B may itself be of different types:
2a.) Site Type B1: a site connected to the network using two MPLS VPN links (e.g., from different Service Providers), with potentially a backup link (e.g., a 3G/4G/5G/LTE connection).
2b.) Site Type B2: a site connected to the network using one MPLS VPN link and one link connected to the public Internet, with potentially a backup link (e.g., a 3G/4G/5G/LTE connection). For example, a particular customer site may be connected to computer network 100 via PE-3 and via a separate Internet connection, potentially also with a wireless backup link.
2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router (e.g., CE router(s) 110) connected to PE-2 and a second CE router (e.g., CE router(s) 110) connected to PE-3.

FIG. 1B illustrates an example of computer network 100 in greater detail, according to various implementations. As shown, network backbone 130 may provide connectivity between devices located in different geographical areas and/or different types of local networks. For example, computer network 100 may comprise local/branch networks (e.g., network 160, network 162) that include devices/nodes 10-16 and devices/nodes 18-20, respectively, as well as a data center/cloud environment 150 that includes servers 152-154. Notably, local networks (e.g., network 160, network 162) and data center/cloud environment 150 may be located in different geographic locations.

Servers 152-154 may include, in various implementations, a network management server (NMS), a dynamic host configuration protocol (DHCP) server, a constrained application protocol (CoAP) server, an outage management system (OMS), an application policy infrastructure controller (APIC), an application server, etc. As would be appreciated, computer network 100 may include any number of local networks, data centers, cloud environments, devices/nodes, servers, etc.

In some implementations, the techniques herein may be applied to other network topologies and configurations. For example, the techniques herein may be applied to peering points with high-speed links, data centers, etc.

According to various implementations, a software-defined WAN (SD-WAN) may be used in computer network 100 to connect local network (e.g., network 160), local network (e.g., network 162), and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network (e.g., network 160) to router CE-1 at the edge of data center/cloud environment 150 over an MPLS or Internet-based service provider network in network backbone 130. Similarly, a second tunnel may also connect these routers over a 4G/5G/LTE cellular service provider network. SD-WAN techniques allow the WAN functions to be virtualized, essentially forming a virtual connection between local network (e.g., network 160) and data center/cloud environment 150 on top of the various underlying connections. Another feature of SD-WAN is centralized management by a supervisory service that can monitor and adjust the various connections, as needed.

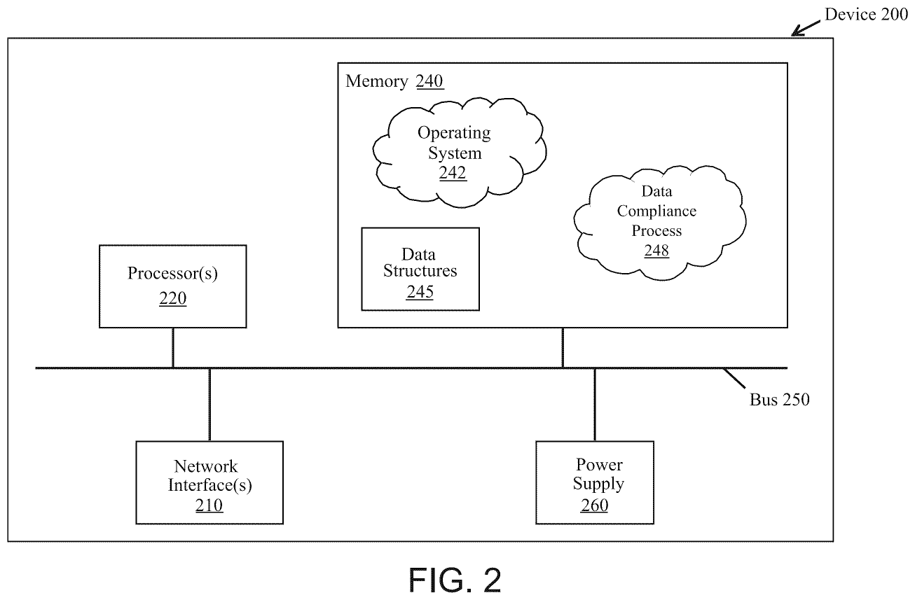

FIG. 2 is a schematic block diagram of an example node/device 200 (e.g., an apparatus) that may be used with one or more implementations described herein, e.g., as any of the computing devices shown in FIGS. 1A-1B, particularly the PE router(s) 120, CE router(s) 110, nodes/device 10-20, servers 152-154 (e.g., a network controller/supervisory service located in a data center, etc.), any other computing device that supports the operations of computer network 100 (e.g., switches, etc.), or any of the other devices referenced below. The device 200 may also be any other suitable type of device depending upon the type of network architecture in place, such as IoT nodes, etc. Device 200 comprises one or more of network interfaces 210, one or more of processor(s) 220, and a memory 240 interconnected by a system bus 250, and is powered by a power supply 260.

The network interfaces 210 include the mechanical, electrical, and signaling circuitry for communicating data over physical links coupled to the computer network 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software components may comprise a data compliance process 248 as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, data compliance process 248 may include computer executable instructions that, when executed by processor(s) 220, cause device 200 to perform the techniques described herein. To do so, in some implementations, data compliance process 248 may utilize and/or involve operations of machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, data compliance process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that data compliance process 248 can employ and/or involve may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, data compliance process 248 may also include and/or involve the operations of one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, data compliance process 248 may use a generative model to generate synthetic network traffic based on existing user traffic to test how the network reacts. Example generative approaches can include, but are not limited to, generative adversarial networks (GANs), large language models (LLMs), other transformer models, and the like.

As noted above, with the proliferation of generative AI, comes increasing challenges with respect to enforcing data governance policies. For instance, given a particular data set, is the enterprise even authorized to use that data set for model training? Indeed, various legal, regulatory, and internal policies may place strict controls over the storage, access, and use of that data (e.g., data minimization rules under GDPR, the upcoming EU AI Act, etc.).

To complicate things further, different geographic jurisdictions have different requirements. This may raise additional questions such as: a.) “What are the differences between geographical jurisdictions under which the original data sets were hosted and the platform and/or the instances in which the data was used/processed for model training purposes?”, b.) “Are those locations and the data transfer compliant with corporate policy and/or legal obligations?”, c.) “In fact, are the chosen pre-trained models lawful processors?”, etc.

Existing identity and access management (IAM) and/or single sign on (SSO) services are not equipped to address and/or ensure answers to these types of data compliance related questions.

### ——Compliance-Based Multi-Factor Authorization——

In contrast, the techniques herein introduce an architecture configured to not only answer the above questions, but also to dynamically determine compliance for a given data set.

Illustratively, the techniques described herein may be performed by hardware, software, and/or firmware, such as in accordance with data compliance process 248, which may include computer executable instructions executed by the processor(s) 220 (or independent processor of network interfaces 210) to perform functions relating to the techniques described herein.

Specifically, according to various implementations, a device identifies an intended action that a user wishes to perform with respect to a service. The device makes a first determination as to whether the user is authorized to access the service. The device causes a chat session with the user to obtain information indicative of a data set, an intended use of the data set, and a data processor to perform the intended action. The device makes, based on the information from the chat session, a second determination as to whether the intended action would violate an access control policy. The device prevents performance of the intended action based on the first determination and on the second determination.

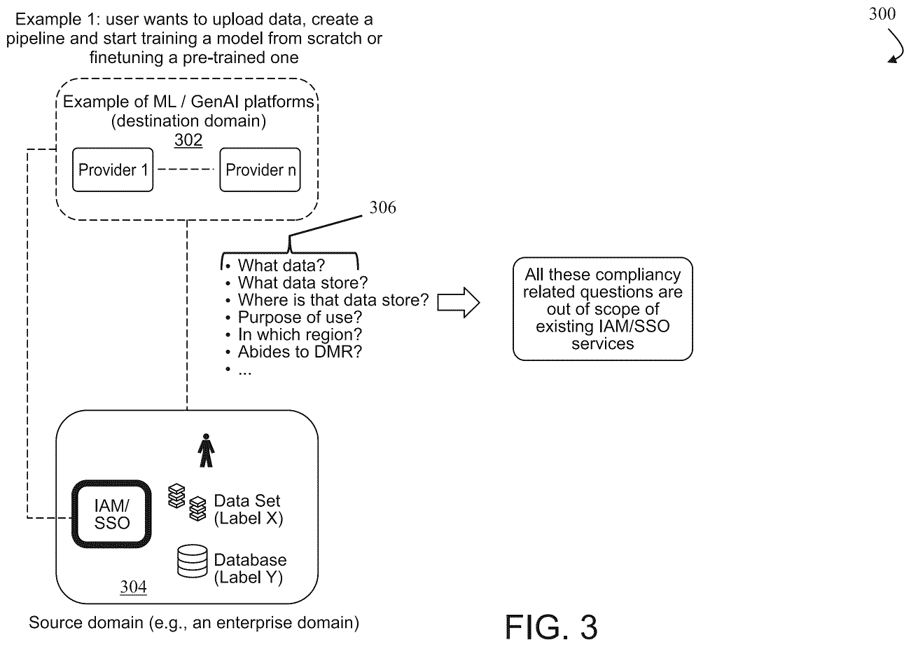

Operationally, FIG. 3 illustrates and example of an environment 300 for ML/GenAI platform 302 training within which an architecture for compliance-based multi-factor authorization may be incorporated, in accordance with various implementations described herein. In environment 300, a user associated with source domain 304 (e.g., an enterprise domain) may want to upload data, create a data pipeline, and start training a model (e.g., ML/GenAI platform 302) from scratch and/or finetune a pre-trained model.

As outlined above, the user may face various challenges with respect to enforcing data governance policies while performing this task. Understanding and meeting the requirements of the data governance polices may ultimately involve the posing and/or answering of various compliance related questions 306 associated with the operation.

For example, as noted above, there are many questions that need to be answered, to determine whether use of a certain data set within a generative AI system would violate any of its governing policies. Some examples of such questions may include “Is the company authorized to use a given data set for model training?”, “Is this compliant with corporate and/or legal obligations in terms of purpose of use?”, “Do the data sets to be used for model training abide to corporate's Data Minimization Rule (DMR)?”, “What regions are involved?”, “What are the differences between geographical jurisdictions under which the original data sets were hosted and the platform and/or the instances in which the data was used/processed for model training purposes?” (e.g., is this a situation where the data set required for the training is in one jurisdiction and potentially the models and/or training pipeline are in another jurisdiction), “Are those locations and the data transfer compliant with corporate policy and/or legal obligations?”, “In fact, are the chosen pre-trained models lawful processors?”. Unfortunately, recognizing and/or resolving these various compliance related questions 306 and others are outside the capability of existing IAM/SSO services.

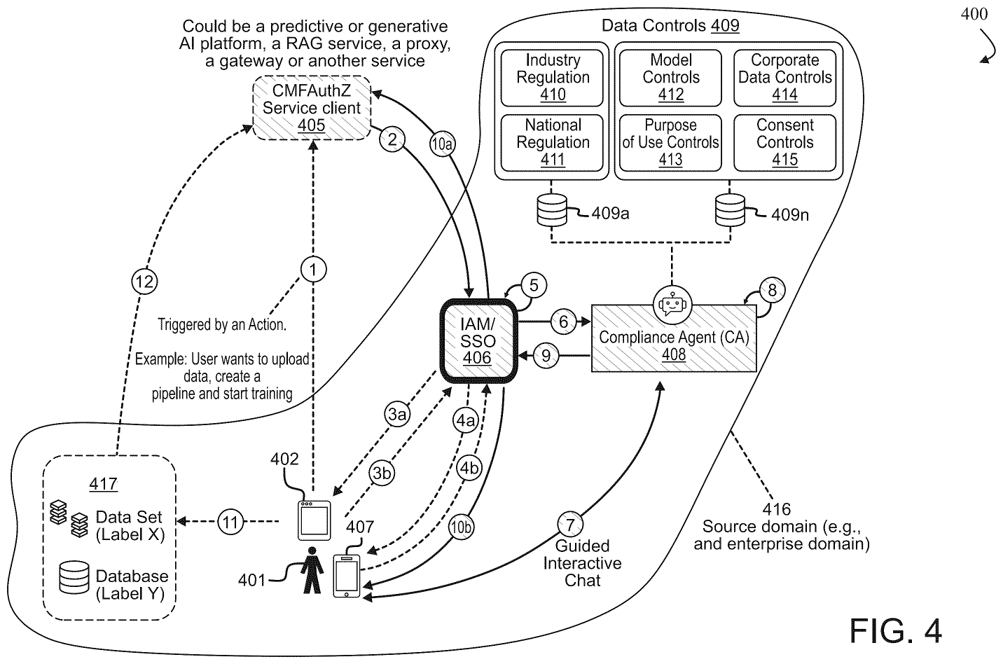

FIG. 4 illustrates an example of an architecture 400 for compliance-based multi-factor authorization (CMFAuthZ), in accordance with various implementations described herein. Architecture 400 may be configured to not only answer the above questions, but also dynamically determine compliance for a given data set. In addition, architecture 400 may be executed within a source domain 416, such as an enterprise domain.

As shown, architecture 400 may include any or all of the following components: a CMFAuthZ service client 405, an IAM/SSO module 406, and/or data controls 409. These components may be implemented as part of data compliance process 248. In various implementations, their functionalities may be combined or omitted as desired. In addition, these components may be executed in a distributed manner, in which case the executing devices may be viewed as a singular device for purposes of the teachings herein.

As shown, architecture 400 may operate as follows:
Step 1: A user 401 operates an endpoint client 402 to trigger an action. For example, the user may attempt to upload data, create a pipeline and start training, or the like.
Step 2: CMFAuthZ service client 405 identifies the intended action and notifies IAM/SSO module 406 as to the action.
Steps 3a-3b: At step 3a, IAM/SSO module 406 prompts the user to enter some information via endpoint client 402, for example, by combining something that the user or process knows (e.g., credentials), has (e.g., a mobile with MDM), and/or is (e.g., biometrics, machine-metrics). At step 3b, endpoint client 402 then returns this information.
Steps 4a-4b: In order to perform multifactor authentication, IAM/SSO module 406 may also send a request at step 4a to a second device 407 associated with user 401 (e.g., a mobile device, etc.). Such a request may seek information regarding user and access control information for a resource, information indicative of whether mobile device management (MDM) software installed on second device 407 is up to date, information regarding the firewall/protection installed, the geolocation of user 401 or device 407, a password or passcode, a verification code generated locally or sent to 407, a one-time pad, or the like. At step 4b, device 407 then returns the requested information to IAM/SSO module 406.
Step 5: IAM/SSO module 406 assesses the information collected in steps 3a-3b and 4a-4b, to determine whether user 401 is authorized to even access the target resource at all. In some implementations, the use of multifactor authentication may be optional and any or all of steps 3a-5 may be omitted or merged as desired.
Step 6: IAM/SSO module 406 sends a request to compliance agent 408 to ensure that the action initiated by user 401 satisfies the various data controls 409 that may apply to the data being passed, accessed, and/or generated by the action. For instance, data controls 409 may include regulatory controls 409a, such as industry regulations 410, national regulations 411, or the like. In addition, data controls 409 may also include further controls 409n, such as model controls 412, purpose of use controls 413, corporate data controls 414, consent controls 415, or the like.
Step 7: To obtain further information about the intended action by user 401, compliance agent 408 may initiate a guided, interactive chat session with user 401, such as via second device 407 or endpoint client 402. During these interactions, the chatbot of compliance agent 408 may obtain the information that it needs to make a compliance determination at access time.
Step 8: Using the information obtained in step 7, compliance agent 408 then makes a compliance determination regarding the intended action with respect to data controls 409.
Step 9: Compliance agent 408 returns the compliance determination back to IAM/SSO module 406.
Steps 10a-10b: IAM/SSO module 406 sends a notification at step 10a to CMFAuthZ service client 405 indicative of the compliance determination and a corresponding notification at step 10b to second device 407 and/or endpoint client 402. In cases in which the action would violate one of data controls 409, the notifications sent to CMFAuthZ service client 405 and/or the device of the user 401 may indicate the specifics of the denial (e.g., what data controls 409 would be violated).
Step 11: Assuming that user 401 has satisfied the full CMFAuthZ criteria, endpoint client 402 may then input the relevant data 417 associated with the action. For instance, data 417 may indicate the data set (Label X) available from a certain data store/database (Label Y) that user 401 wishes to use to train a machine learning model.
Step 12: Data 417 is passed to CMFAuthZ service client 405, which may in turn redirect the data upload to another endpoint (e.g., another services) for performance of the action within the system that CMFAuthZ service client 405 is part of. In other instances, data 417 may be passed directly to another endpoint or service, potentially bypassing CMFAuthZ service client 405 in step (12). Such endpoint could be pushed by CMFAuthZ service client 405 as a callback identifier (e.g., a URI) in step (2), and subsequently passed to the second device 407 and/or endpoint client 402 at step 10b.

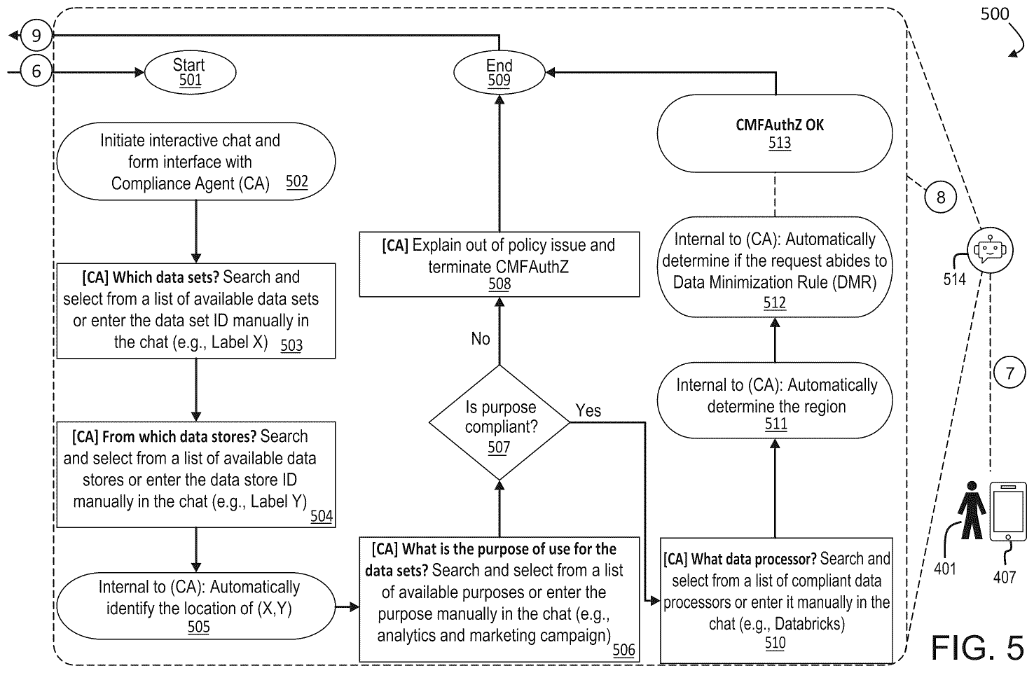

FIG. 5 illustrates an example of operations 500 of compliance agent 408 in FIG. 4, according to various implementations. As noted, compliance agent 408 may be responsible for performing Steps 6-9 above. Here, operations 500 may start at block 501 in response to compliance agent 408 receiving a request from IAM/SSO module 406 at Step 6 above. In turn, compliance agent 408 may initiate at block 502 an interactive chat via chatbot 514 with user 401 (e.g., using second device 407 shown), to perform Step 7 above.

At block 503, compliance agent 408 may ask via the chat session which data set(s) user 401 intends to use with respect to the action (e.g., data 417). For instance, chatbot 514 may ask user 401 to select from among a list of available data sets (e.g., leveraging corporate data controls 414 in further controls 409n) or enter a data set ID manually in the chat (e.g., Label X).

Similarly, at block 504, compliance agent 408 may ask via the chat session the intended data store(s) from which data 417 is to be sourced. For instance, compliance agent 408 may use chatbot 514 to ask user 401 to select the source(s) from among the list of available data stores (e.g., leveraging corporate data controls 414 in further controls 409n) or to enter the data store ID manually in the chat (e.g., Label Y).

At block 505, compliance agent 408 may use corporate data controls 414 in further controls 409n to automatically identify the location of the specified data set(s) and their corresponding data store(s) indicated via chatbot 514.

At block 506, compliance agent 408 may further ask user 401 via chatbot 514 what their intended purpose of use of the data is for their intended action. To do so, chatbot 514 may ask user 401 to select from among a list of available purposes or to enter the purpose manually in the chat (e.g., “as part of an analytics and marketing campaign”). To this end, chatbot 514 may dynamically use, correlate, and present information from purpose of use controls 413, consent controls 415, and corporate data controls 414 stored in further controls 409n.

At block 507, compliance agent 408 may use the answers from the chat session in blocks 503, 504, and 506 to determine whether this would satisfy data controls 409. For instance, even if user 401 has been authenticated via multifactor authentication, is generally authorized to use the system to train a machine learning model, and even is authorized to access the intended training data set (e.g., contact information for potential customers or other personally identifiable information), compliance agent 408 may still determine that the intended use (e.g., training a machine learning model to aid in a marketing campaign) may violate data controls 409.

At block 508, if compliance agent 408 determines that the action would constitute a compliance violation, it may generate an explanation to notify user 401 as to the denial. At block 510, if the purpose of the action does satisfy data controls 409, compliance agent 408 may also ask user 401 via chatbot 514 what the data processor is going to be. For instance, it may ask user 401 to select a data processor from among a list of compliant data processors (e.g., leveraging model controls 412 in further controls 409n) or to enter it manually (e.g., a specific LLM model and version, available at a specific instance of Databricks, in a specific region).

At block 511, compliance agent 408 may augment the answer obtained in block 510 with a geographic region or location associated with the selected data processor.

At block 512, compliance agent 408 may determine whether the requested action would abide to one or more data minimization rules (DMRs).

As would be appreciated, compliance agent 408 may assess the answers at block 510 and block 512, and use industry regulation 410 and national regulation 411 stored in regulatory controls 409a to determine whether these answers would constitute violations, in a similar manner to block 507. In some cases, compliance agent 408 may wait until the end of its chat interactions with user 401 to make a final determination. However, further implementations provide for compliance agent 408 to perform its various checks against data controls 409 in an incremental manner, so as to avoid asking user 401 to enter further information if their previous answers indicate that there would be a violation.

Finally, at block 513, compliance agent 408 may determine that the action and user 401 have satisfied all CMFAuthZ checks. In turn, at block 509, compliance agent 408 may send the authorization notification to IAM/SSO module 406, accordingly. Conversely, if compliance agent 408 determines that there would be a policy violation, at block 509, compliance agent 408 may provide an indication of this and possibly an explanation, as well. In either case, compliance agent 408 returns the results according to Step 9 described previously in FIG. 4.

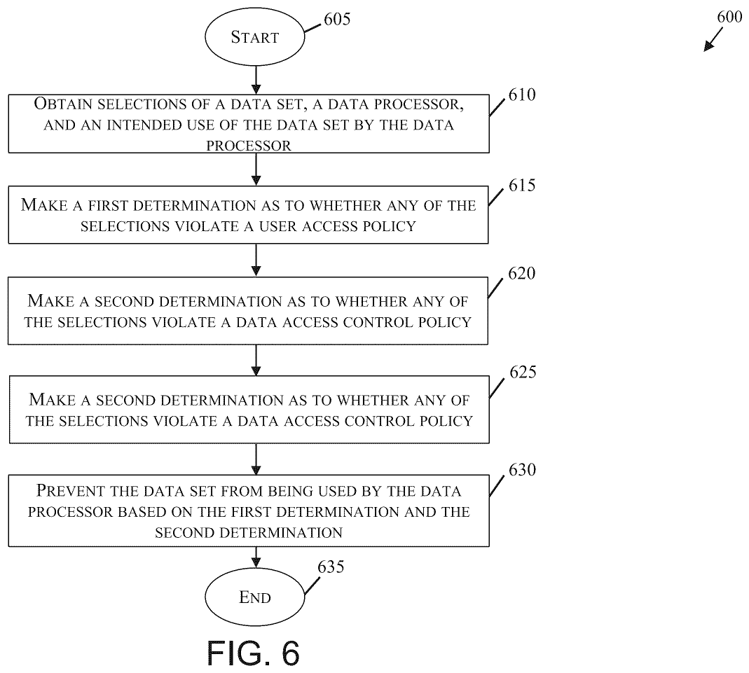

FIG. 6 illustrates an example simplified procedure for compliance-based multi-factor authorization, in accordance with one or more implementations described herein. For example, a non-generic, specifically configured device (e.g., device 200), may perform procedure 600 (e.g., a method) by executing stored instructions (e.g., data compliance process 248).

The procedure 600 may start at step 605, and continues to step 610, where, as described in greater detail above, the device (e.g., a controller, server, networking device, etc.) may identify an intended action that a user wishes to perform with respect to a service. In some implementations, the intended action comprises training a machine learning model using the data set and by the data processor.

At step 615, as detailed above, the device may make a first determination as to whether the user is authorized to access the service. In some instances, making the first determination comprises performing multifactor authentication of the user. In such instances, the multifactor authentication of the user may occur prior to and/or at the time of an initiation of the chat session outlined below. In various implementations, making the first determination may include determining whether any of the data set, an intended use of the data set, and a data processor to perform the intended action (e.g., obtained in step 620) violate a data access policy associated with the user. In such instances where the first determination relies on the information obtained from the chat session, step 615 may occur temporally after initiation of the chat session and/or after step 620.

At step 620, the device may cause a chat session with the user to obtain information indicative of a data set, an intended use of the data set, and a data processor to perform the intended action, as described in greater detail above. In various implementations, obtaining the information may include logging the information. In various instances, the chat session asks the user to specify the data set, the intended use of the data set, and the data processor to perform the intended action. In one instance, the device causes the chat session via a different endpoint associated with the user than that used by the user to indicate the intended action. In some implementations, the data set includes personally identifiable information.

At step 625, as detailed above, the device may make, based on the information from the chat session, a second determination as to whether the intended action would violate an access control policy. In various implementations, the access control policy comprises at least one of: an industry regulation or a legal regulation. In one case, the access control policy comprises a data minimization rule. In further implementations, the access control policy restricts performance of the intended action based on a geolocation of one of: the user, the data set, or the data processor.

At step 630, the device may prevent performance of the intended action based on the first determination and on the second determination, as described in greater detail above. In some implementations, the device may also provide an indication to the user as to why performance of the intended action was prevented.

Procedure 600 then ends at step 635.

It should be noted that while certain steps within procedure 600 may be optional as described above, the steps shown are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for compliance-based multi-factor authorization, it is to be understood that various other adaptations and modifications may be made within the spirit and scope of the implementations herein. For example, while certain implementations are described herein with respect to addressing certain compliancy related questions and/or utilizing certain data control components and/or data repositories for authentication and authorization, these elements are not limited as such and other types of questions, control components, data repositories, etc. may be utilized, in other implementations. In addition, while certain protocols are shown, other suitable protocols may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

What is claimed is:

1. A method, comprising:
identifying, by a device, an intended action that a user wishes to perform with respect to a service;
making, by the device, a first determination as to whether the user is authorized to access the service;
causing, by the device, a chat session with the user to obtain information indicative of a data set, an intended use of the data set, and a data processor to perform the intended action;
making, by the device and based on the information from the chat session, a second determination as to whether the intended action would violate an access control policy; and
preventing, by the device, performance of the intended action based on the first determination and on the second determination.

2. The method as in claim 1, wherein the intended action comprises training a machine learning model using the data set and by the data processor.

3. The method as in claim 1, wherein making the first determination comprises performing multifactor authentication of the user.

4. The method as in claim 1, wherein the access control policy comprises at least one of:
an industry regulation or a legal regulation.

5. The method as in claim 1, wherein the chat session asks the user to specify the data set, the intended use of the data set, and the data processor to perform the intended action.

6. The method as in claim 5, wherein the device causes the chat session via a different endpoint associated with the user than that used by the user to indicate the intended action.

7. The method as in claim 1, wherein the access control policy comprises a data minimization rule.

8. The method as in claim 1, wherein the access control policy restricts performance of the intended action based on a geolocation of one of: the user, the data set, or the data processor.

9. The method as in claim 1, further comprising:
providing, by the device, an indication to the user as to why performance of the intended action was prevented.

10. The method as in claim 1, wherein the data set includes personally identifiable information.

11. An apparatus, comprising:
one or more network interfaces;
a processor coupled to the one or more network interfaces and configured to execute one or more processes; and
a memory configured to store a process that is executable by the processor, the process when executed configured to:
identify an intended action that a user wishes to perform with respect to a service;
make a first determination as to whether the user is authorized to access the service;
cause a chat session with the user to obtain information indicative of a data set, an intended use of the data set, and a data processor to perform the intended action;
make, based on the information from the chat session, a second determination as to whether the intended action would violate an access control policy; and
prevent performance of the intended action based on the first determination and on the second determination.

12. The apparatus as in claim 11, wherein the intended action comprises training a machine learning model using the data set and by the data processor.

13. The apparatus as in claim 11, wherein making the first determination comprises performing multifactor authentication of the user.

14. The apparatus as in claim 11, wherein the access control policy comprises at least one of: an industry regulation or a legal regulation.

15. The apparatus as in claim 11, wherein the chat session asks the user to specify the data set, the intended use of the data set, and the data processor to perform the intended action.

16. The apparatus as in claim 15, wherein the apparatus causes the chat session via a different endpoint associated with the user than that used by the user to indicate the intended action.

17. The apparatus as in claim 11, wherein the access control policy comprises a data minimization rule.

18. The apparatus as in claim 11, wherein the access control policy restricts performance of the intended action based on a geolocation of one of: the user, the data set, or the data processor.

19. The apparatus as in claim 11, wherein the process when executed is further configured to:
provide an indication to the user as to why performance of the intended action was prevented.

20. A tangible, non-transitory, computer-readable medium storing program instructions that cause a device to execute a process comprising:
identifying, by the device, an intended action that a user wishes to perform with respect to a service;
making, by the device, a first determination as to whether the user is authorized to access the service;
cause, by the device, a chat session with the user to obtain information indicative of a data set, an intended use of the data set, and a data processor to perform the intended action;
making, by the device and based on the information from the chat session, a second determination as to whether the intended action would violate an access control policy; and
preventing, by the device, performance of the intended action based on the first determination and on the second determination.
